(19) United States
(12) Patent Application Publication
(10) Pub. No.: US 2019/0147104 A1
(43) Pub. Date: May 16, 2019

(54) METHOD AND APPARATUS FOR CONSTRUCTING ARTIFICIAL INTELLIGENCE APPLICATION

(71) Applicant: Baidu Online Network Technology (Beijing) Co., Ltd, Beijing (CN)

(72) Inventors: Liangcheng WU, Beijing (CN); Xiaoli TIAN, Beijing (CN); Jingya WANG, Beijing (CN); Tao YANG, Beijing (CN); Zhenchao JIA, Beijing (CN); Tian WANG, Beijing (CN); Huan TANG, Beijing (CN); Peng YUAN, Beijing (CN); Lei ZHONG, Beijing (CN)

(21) Appl. No.: 16/133,405

(22) Filed: Sep. 17, 2018

(30) Foreign Application Priority Data
Nov. 16, 2017 (CN) 201711137331.X

(51) Int. Cl. G06F 17/30; G10L 15/22; G10L 15/06

(52) U.S. Cl. CPC G06F 17/30707; G06F 17/30713; G10L 2015/223; G10L 15/063; G10L 2015/0636; G10L 15/22

(57) ABSTRACT

A method and apparatus for constructing an artificial intelligence application are provided. A specific embodiment of the method includes: acquiring a content description document corresponding to a piece of content provided by a content supplier and a hierarchical relationship between content categories; analyzing the content description document to obtain a content attribute, and constructing an operation description template based on the hierarchical relationship between the content categories, or the content attribute; binding the operation description template to a preset interface of an operation type of an operation described by the operation description template; and constructing an artificial intelligence application using the operation description template and the preset interface bound to the operation description template.

### CROSS-REFERENCE TO RELATED APPLICATIONS

This application claims priority to Chinese Patent Application no. 201711137331.X, filed with the China National Intellectual Property Administration (CNIPA) on Nov. 16, 2017, the contents of which are incorporated herein by reference in their entirety.

### TECHNICAL FIELD

The disclosure relates to the computer field, specifically to the field of artificial intelligence, and more specifically to a method and apparatus for constructing an artificial intelligence application.

### BACKGROUND

Man-machine dialogue function is a basic function in an artificial intelligence (AI for short) application or a smart device integrated with the artificial intelligence application. Accurately identifying the user's operative intention and invoking corresponding functions based on the identified operative intention result are most critical processes of the man-machine dialogue function.

However, because of the complexities of the user needs for the artificial intelligence application and the complexities of the logic in realizing the man-machine dialogue, it is difficult for personnel of the content supplier specialized in making articles, audio books, and the like to develop the man-machine dialogue function, resulting in the difficulty in developing artificial intelligence applications capable of accessing a piece of content provided by the content supplier through the man-machine dialogue. Therefore, the users are unable to acquire the piece of content provided by the content supplier through the man-machine dialogue.

### SUMMARY

Some embodiments of the present disclosure presents a method and apparatus for constructing an artificial intelligence application.

Some embodiments of the present disclosure provide a method for constructing an artificial intelligence application. The method includes: acquiring a content description document corresponding to a piece of content provided by a content supplier and a hierarchical relationship between content categories, the content description document including: a content attribute defined in a preset format; analyzing the content description document using an analysis method corresponding to the preset format to obtain the content attribute, and constructing an operation description template based on the hierarchical relationship between the content categories, or the content attribute, the operation description template used for matching a sentence corresponding to a user-entered voice; binding the operation description template to a preset interface of an operation type of an operation described by the operation description template, the preset interface being encapsulated with code for executing the operation described by the operation description template based on the content attribute, the preset interface being invoked when the bound operation description template matches the sentence corresponding to the user-entered voice; and constructing an artificial intelligence application capable of accessing the piece of content provided by the content supplier through a man-machine dialogue using the operation description template and the preset interface bound to the operation description template.

Some embodiments of the present disclosure provide an apparatus for constructing an artificial intelligence application. The apparatus includes: an acquisition unit, configured for acquiring a content description document corresponding to a piece of content provided by a content supplier and a hierarchical relationship between content categories, the content description document including: a content attribute defined in a preset format; a processing unit, configured for analyzing the content description document using an analysis method corresponding to the preset format to obtain the content attribute, and constructing an operation description template based on the hierarchical relationship between the content categories, or the content attribute, the operation description template used for matching a sentence corresponding to a user-entered voice; a binding unit, configured for binding the operation description template to a preset interface of an operation type of an operation described by the operation description template, the preset interface being encapsulated with code for executing the operation described by the operation description template based on the content attribute, the preset interface being invoked when the bound operation description template matches the sentence corresponding to the user-entered voice; and a construction unit, configured for constructing an artificial intelligence application capable of accessing the piece of content provided by the content supplier through a man-machine dialogue using the operation description template and the preset interface bound to the operation description template.

The method and apparatus for constructing an artificial intelligence application provided by some embodiments of the disclosure acquire a content description document corresponding to a piece of content provided by a content supplier and a hierarchical relationship between content categories, the content description document including: a content attribute defined in a preset format; analyze the content description document using an analysis method corresponding to the preset format to obtain the content attribute, and construct an operation description template based on the hierarchical relationship between the content categories, or the content attribute, the operation description template used for matching a sentence corresponding to a user-entered voice; bind the operation description template to a preset interface of an operation type of an operation described by the operation description template, the preset interface being encapsulated with code for executing the operation described by the operation description template based on the content attribute, the preset interface being invoked when the bound operation description template matches the sentence corresponding to the user-entered voice; and construct an artificial intelligence application capable of accessing the piece of content provided by the content supplier through a man-machine dialogue using the operation description template and the preset interface bound to the operation description template. Some embodiments of the present disclosure have realized automatically constructing a template for identifying a user's operative intention based on a piece of content provided by a content supplier and binding the template to a corresponding executable operation, thereby achieving the man-machine dialogue function, and further constructing an artificial intelligence application capable of accessing the piece of content provided by the content supplier through the man-machine dialogue.

### BRIEF DESCRIPTION OF THE DRAWINGS

By reading and referring to detailed description on the non-limiting embodiments in the following accompanying drawings, other features, objects and advantages of the disclosure will become more apparent:

FIG. 1 shows an illustrative system architecture which may be applied in a method or apparatus for constructing an artificial intelligence application according to some embodiments of the disclosure;

FIG. 2 shows a process diagram of an embodiment of a method for constructing an artificial intelligence application according to the disclosure;

FIG. 3 shows a schematic diagram of a structure of an embodiment of an apparatus for constructing an artificial intelligence application according to the disclosure; and

FIG. 4 shows a schematic diagram of a structure of a computer system suitable for implementing a server according to an embodiment of the disclosure.

### DETAILED DESCRIPTION OF EMBODIMENTS

The present application will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

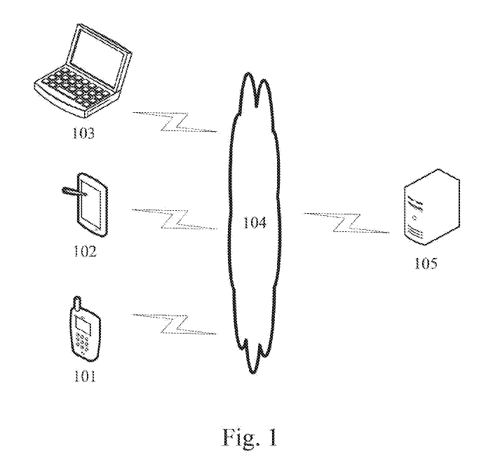

FIG. 1 shows an illustrative system architecture which may be applied in a method or apparatus for constructing an artificial intelligence application according to some embodiments of the disclosure.

As shown in FIG. 1, the system architecture may include terminals 101, 102, and 103, a network 104, and a server 105. The network 104 is used for providing a communication link medium between the terminals 101, 102, and 103, and the server 105. The network 104 may include a variety of connection types, such as a wired transmission link, a wireless transmission link, or a fiber cable.

The terminal 101, 102, or 103 may be a terminal belonging to a content supplier, for example, a terminal used by personnel of the content supplier. The content supplier may be a content creator, a content production company, or the like. The terminal 101, 102, or 103 may interact with the server 105 through the network 104, to receive or send messages, etc. The terminals 101, 102, and 103 may be a variety of terminals having display screens and supporting network communication, including but not limited to smartphones, tablet computers, ebook readers, laptops, and the like.

The server 105 may be deployed in cloud. The server 105 may receive a content description document sent by the terminal 101, 102, or 103, and automatically construct a plurality of operation description templates. Each of the operation description templates is respectively bound to a corresponding preset interface. Moreover, the plurality of operation description templates and the bound preset interfaces may be combined with a voice recognition module or a broadcast module of an artificial intelligence operating system, to realize a man-machine dialogue function, thereby automatically constructing an artificial intelligence application capable of accessing a piece of content provided by the content supplier through a man-machine dialogue, and providing the content supplier with the artificial intelligence application accessing the piece of content provided by the content supplier through the man-machine dialogue. The artificial intelligence application may be an APP running on the terminal.

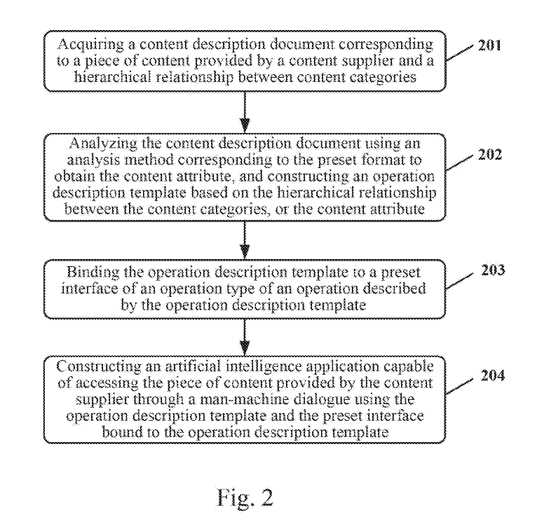

Referring to FIG. 2, a process of an embodiment of a method for constructing an artificial intelligence application according to the disclosure is shown. It should be noted that the method for constructing an artificial intelligence application provided by an embodiment of the disclosure may be executed by a server (for example, the server 105 in FIG. 1). The method includes:

step 201: acquiring a content description document corresponding to a piece of content provided by a content supplier and a hierarchical relationship between content categories.

In the embodiment, when a content supplier expects to develop an artificial intelligence application capable of accessing a piece of content provided by the content supplier through a man-machine dialogue, the content supplier may first construct a content description document on a terminal of the content supplier. The content supplier may define the piece of content provided by the content supplier in the content description document in a preset format. The preset format may include, but is not limited to, labels and a nested relationship between the labels. A type of content attribute may correspond to a label. Each content attribute may be provided in a respective label corresponding to an attribute of the content attribute. A terminal belonging to the content supplier may send the content description document to the server, thereby enabling the server to acquire the content description document. Moreover, the terminal belonging to the content supplier may send a hierarchical relationship between content categories to the server. Description information describing the hierarchical relationship between the content categories in Baijiahao may be generated in the terminal belonging to the content supplier, and the content categories and the description information may be sent to the server. Thus, the server may acquire the hierarchical relationship between the content categories.

For example, the name of the content supplier is the Baijiahao, the content categories of the Baijiahao include domestic category, international category, sports, entertainment, society, finance, technology, real estate, automobile, education, game, military, Internet, and the like, and each category further includes content subcategories, such as news, channels, and information. The description information describing the hierarchical relationship between the content categories in the Baijiahao may be generated in the terminal belonging to the content supplier, and the content categories and the description information may be sent to the server. Thus, the server may acquire the hierarchical relationship between the content categories in the Baijiahao based on the description information.

In the embodiment, the content attribute of the piece of content provided by the content supplier may include, but is not limited to: a storage address of the piece of content, updating time of the piece of content, a content category of the piece of content, and an author of the piece of content.

For example, the piece of content provided by the content supplier is articles or audio books. For each of a plurality of the articles or audio books, a content description document corresponding to the each of the plurality of articles or audio books may be generated respectively in the terminal belonging to the content supplier. Each of the plurality of articles may have a content description document. The terminal belonging to the content supplier may send the content description documents of the plurality of articles or audio books to the server.

step 202: analyzing the content description document to obtain the content attribute, and constructing an operation description template based on the hierarchical relationship between the content categories, or the content attribute.

In the embodiment, after receiving the content description document, the content description document may be analyzed using an analysis method corresponding to the preset format, to obtain the content attribute. The preset format includes, but is not limited to, labels and a nested relationship between the labels.

The content description document may be analyzed by retrieving a corresponding content attribute from each label in the document based on a corresponding relationship between the label and the content attribute, thereby obtaining the content attribute of the piece of content.

In the embodiment, an operation description template may be constructed based on the hierarchical relationship between the content categories, or the content attribute. The operation description template is used for matching a sentence corresponding to a user-entered voice. The user may refer to a user of the constructed artificial intelligence application capable of accessing the piece of content provided by the content supplier through the man-machine dialogue.

For example, when the name of the content supplier is Baijiahao, if a user of the artificial intelligence application capable of accessing the piece of content provided by the content supplier through the man-machine dialogue wishes to view a piece of content of the Baijiahao, the user will enter a voice of a sentence “opening the Baijiahao.” The voice may be first recognized to obtain the sentence “opening the Baijiahao.” Because of presetting an operation description template {opening, Baijiahao}, the operation description template may be matched.

In some optional implementations of the embodiment, the operation description template constructed based on the hierarchical relationship between the content categories may contain a word associated with the operation type of the operation described by the operation description template, and a name of the content supplier.

For example, the name of the content supplier is the Baijiahao, and the operation description template contains the word associated with the operation type, such as “opening,” “playing,” “I would like to see,” and “I would like to listen to,” and the name of the content supplier, i.e., the Baijiahao. The operation description template, such as {opening, Baijiahao}, {I would like to see, Baijiahao}, {playing, Baijiahao}, and {I would like to listen to, Baijiahao}, may be constructed.

In some optional implementations of the embodiment, the operation description template constructed based on the hierarchical relationship between the content categories may contain the word associated with the operation type of the operation described by the operation description template, such as “opening,” “playing,” “I would like to see,” or “I would like to listen to.” The operation description template constructed based on the hierarchical relationship between the content categories may contain the name of the content supplier such as the Baijiahao, or the content categories. There may be a plurality of content categories. When there are a plurality of content categories in the constructed content description template, the order between the content categories is related to the hierarchical relationship between the content categories.

For example, the order between the content categories of the content supplier in the constructed content description template is related to the hierarchical relationship between the content categories represented by the words associated with the pieces of content of the Baijiahao. For example, the content category of news is a type subordinate to the content category of technology, and the order of the words in the operation description template is technology, and news.

In the embodiment, the constructed operation description template containing the word associated with the operation type of the operation described by the operation description template, the name of the content supplier, and the content category may be used for identifying the user's operation associated with the pieces of content in the content category provided by the content supplier.

For example, the name of the content supplier is the Baijiahao. The operation description template contains the word associated with the operation type of the operation described by the operation description template, the name of the content supplier, i.e., the Baijiahao, and a plurality of content categories, such as “technology,” “news.” The operation description templates {opening, Baijiahao, technology, news}, {I would like to see, technology, news}, {playing, Baijiahao, technology, news}, and {I would like to listen to, Baijiahao, technology, news} may be used for identifying more detailed operations associated with technological news of the Baijiahao expected by the user of the artificial intelligence application to be performed by the artificial intelligence application.

After the artificial intelligence application integrating a plurality of operation description templates and capable of accessing the piece of content provided by the content supplier through the man-machine dialogue is constructed, and when the user of the artificial intelligence application enters a voice, such as “opening the Baijiahao,” “playing the Baijiahao,” “I would like to see the Baijiahao,” “I would like to listen to the Baijiahao,” “opening technological news of the Baijiahao,” “playing technological news of the Baijiahao,” “I would like to see technological news of the Baijiahao,” “I would like to listen to technological news of the Baijiahao,” “opening the Silicon Valley Insight of the Baijiahao,” “playing the Silicon Valley Insight of the Baijiahao,” “I would like to see the Silicon Valley Insight of the Baijiahao,” or “I would like to listen to the Silicon Valley Insight of the Baijiahao,” the voice will be first converted into a sentence through a voice recognition function, and may be matched with a corresponding template constructed using the solution, thereby executing a subsequent operation.

In some optional implementations of the embodiment, the operation description template constructed based on the content attribute may contain the word associated with the operation type of the operation described by the operation description template, such as “opening,” “playing,” “I would like to see,” or “I would like to listen to.” The operation description template constructed based on the content attribute may contain the name of the content supplier such as the Baijiahao, or the content attribute.

In the embodiment, the constructed description template containing the word associated with the operation type of the operation described by the operation description template, the name of the content supplier, and the content attribute may be used for identifying the user's operation associated with the pieces of content having the content attribute provided by the content supplier.

For example, the name of the content supplier is the Baijiahao. The operation description template contains the word associated with the operation type of the operation described by the operation description template, the name of the content supplier, i.e., the Baijiahao, and the content attribute, such as an author name Silicon Valley Insight of the pieces of content, the operation description templates {opening, Baijiahao, Silicon Valley Insight. The operation description templates {I would like to see, Baijiahao, Silicon Valley Insight}, {playing, Baijiahao, Silicon Valley Insight}, and {I would like to listen to, Baijiahao, Silicon Valley Insight} may be used for identifying more detailed operations associated with the pieces of content with the author of the Baijiahao being the Silicon Valley Insight expected by a user of the artificial intelligence application to be performed by the artificial intelligence application.

step 203: binding the operation description template to a preset interface of an operation type of an operation described by the operation description template.

In the embodiment, each operation description template may be automatically bound to a preset interface of an operation type of an operation described by the operation description template respectively. The preset interface is encapsulated with code for executing the operation described by the operation description template based on the content attribute, and is invoked when the bound operation description template matches the sentence corresponding to the user-entered voice. The operation described by the operation description template can be completed through the bound interface without the need of designing by personnel of the content supplier any detail on executing the operation.

Thus, when the operation description template matches a corresponding sentence, the operation expected by the user to be completed by the artificial intelligence application can be identified, and the interface bound to the operation description template can be invoked, to complete the operation described by the operation description template.

The operation type of an operation described by the operation description template may include, but is not limited to: opening a piece of content, and playing a piece of content. When the operation description template contains the words, such as “opening,” and “I would like to see,” the operation type of the operation described by the operation description template may be determined as opening a piece of content. When the operation description template contains the words, such as “playing,” and “I would like to listen to,” the operation type of the operation described by the operation description template may be determined as playing a piece of content.

In the embodiment, a preset interface corresponding to the type of opening a piece of content, and a preset interface corresponding to the type of playing a piece of content may be pre-implemented respectively. The preset interface corresponding to the type of opening a piece of content is encapsulated with code of a logic in opening the pieces of content of a specific category, while the preset interface corresponding to the type of playing a piece of content is encapsulated with code of a logic in playing the pieces of content of a specific category.

For example, the operation described by the operation description template {opening, Baijiahao}, and the operation description template {opening, Baijiahao, technology, news} are opening the Baijiahao, and opening technological news of the Baijiahao respectively. Both of the two operations belong to the type of opening a piece of content, have an identical logic in opening a piece of content, and open different pieces of content. The preset interface corresponding to opening a piece of content is encapsulated with the code of the logic in opening a piece of content. The logic in opening a piece of content may be opening articles in a content category, sorting the articles based on the updating time, and then returning the sorted articles.

The operations corresponding to the operation description template {playing, Baijiahao, finance, information}, {playing, Baijiahao, 36Kr} are playing financial information of the Baijiahao, and playing the 36Kr of the Baijiahao respectively. Both of the two operations belong to the type of playing a piece of content, have an identical logic in playing a piece of content, and play different pieces of content.

In the embodiment, the operation description template corresponding to the type of opening a piece of content will be automatically bound to a preset interface corresponding to the type of opening a piece of content, while the operation description template corresponding to the type of playing a piece of content will be automatically pre-bound to a preset interface corresponding to the type of playing a piece of content.

In some optional implementations of the embodiment, when the operation type of the operation described by the constructed operation description template is opening a piece of content, and when the constructed operation description template containing the word associated with the operation type of the operation described by the operation description template, and the name of the content supplier matches the sentence corresponding to the voice entered by the user of the artificial intelligence application, the preset interface bound to the operation description template executed by the interface bound to the operation description template, when invoked, is used for: finding out the articles having a time length from the updating time to current time shorter than a time length threshold among all of the articles provided by the content supplier; sorting the found articles based on the time length from the updating time to the current time; and displaying the sorted articles to the user of the artificial intelligence application capable of accessing the piece of content provided by the content supplier through the man-machine dialogue.

For example, after an artificial intelligence application integrated with a plurality of operation description templates and capable of accessing the piece of content provided by the content supplier through the man-machine dialogue is constructed, the user of the artificial intelligence application inputs “opening the Baijiahao,” which will match the operation description template {opening, Baijiahao}. As long as the actual operation transfers a parameter Baijiahao into a pre-bound preset interface of {opening, Baijiahao}, the interface may be invoked to execute a logic in opening to find out all recently updated articles of the Baijiahao, and then return the recently updated articles of the Baijiahao in reverse chronological order with the latest updated article in front.

In some optional implementations of the embodiment, when the operation type of the operation described by the constructed operation description template is opening a piece of content, and when the constructed operation description template containing the word associated with the operation type of the operation described by the operation description template, the name of the content supplier, and the content category matches the sentence corresponding to the voice entered by a user of the artificial intelligence application, the preset interface bound to the operation description template executed by the interface bound to the operation description template, when invoked, is used for: finding out the articles belonging to the content category having a time length from the updating time to current time shorter than a time length threshold provided by the content supplier; sorting the found articles based on the time length from the updating time to the current time; and displaying the sorted articles to the user of the artificial intelligence application capable of accessing the piece of content provided by the content supplier through the man-machine dialogue.

For example, after an artificial intelligence application integrated with a plurality of operation description templates and capable of accessing the piece of content provided by the content supplier through the man-machine dialogue is constructed, a user of the artificial intelligence application enters “opening technological news of the Baijiahao,” which matches the operation description template {opening, Baijiahao, technology, news}. As long as the actual operation transfers parameters Baijiahao, technology, and news into a pre-bound interface of the operation description template {opening, Baijiahao, technology, news}, the preset interface may be invoked to execute a logic in opening a piece of content to find out recently updated articles of technological news of the Baijiahao, and then return the recently updated articles of technological news of the Baijiahao in reverse chronological order with the latest updated articles in front.

In some optional implementations of the embodiment, when the operation type of the operation described by the constructed operation description template is opening a piece of content, and when the constructed operation description template containing the word associated with the operation type of the operation described by the operation description template, the name of the content supplier, and the content attribute, such as the author name of the pieces of content Silicon Valley Insight, matches the sentence corresponding to the voice entered by a user of the artificial intelligence application, the preset interface bound to the operation description template executed by the interface bound to the operation description template, when invoked, is used for: finding out the articles having the content attribute having a time length from the updating time to the current time shorter than the time length threshold provided by the content supplier; sorting the found articles based on the time length from the updating time to the current time; and displaying the sorted articles to the user of the artificial intelligence application capable of accessing the piece of content provided by the content supplier through the man-machine dialogue.

For example, after an artificial intelligence application integrated with a plurality of operation description templates and capable of accessing the piece of content provided by the content supplier through the man-machine dialogue is constructed, a user of the artificial intelligence application enters “opening the Silicon Valley Insight of the Baijiahao,” which matches the operation description template {opening, Baijiahao, Silicon Valley Insight}. As long as the actual operation transfers parameters Baijiahao, and Silicon Valley Insight into a pre-bound preset interface of the operation description template {opening, Baijiahao, Silicon Valley Insight}, the preset interface may be invoked to execute a logic in opening a piece of content to find out recently updated articles of the author Silicon Valley Insight of the Baijiahao based on a storage address and the updating time in the content attribute of the articles, and then return the recently updated articles with the author of the Baijiahao being the Silicon Valley Insight in reverse chronological order with the latest updated articles in front.

In some optional implementations of the embodiment, when the operation type of the operation described by the constructed operation description template is playing a piece of content, and when the constructed operation description template containing the word associated with the operation type of the operation described by the operation description template, and the name of the content supplier matches the sentence corresponding to the voice entered by a user of the artificial intelligence application, the preset interface bound to the operation description template executed by the interface bound to the operation description template, when invoked, is used for: finding out articles having a time length from the updating time to the current time shorter than the time length threshold among all of the articles provided by the content supplier; sorting the found articles based on the time length from the updating time to the current time; and successively playing the articles in an order of the sorted articles.

For example, after an artificial intelligence application integrated with a plurality of operation description templates and capable of accessing the piece of content provided by the content supplier through the man-machine dialogue is constructed, a user of the artificial intelligence application enters “playing the Baijiahao,” which will match the operation description template {playing, Baijiahao}. As long as the actual operation transfers the parameter Baijiahao into a pre-bound preset interface of {playing, Baijiahao}, the interface may be invoked to execute a logic in playing a piece of content to find out all recently updated articles of the Baijiahao based on the storage address and the updating time in the content attribute of the articles, and then play a piece of content of each article among all of the recently updated articles of the Baijiahao one by one.

In some optional implementations of the embodiment, when the operation type of the operation described by the constructed operation description template is playing a piece of content, and when the constructed operation description template containing the word associated with the operation type of the operation described by the operation description template, the name of the content supplier, and the content category matches the sentence corresponding to the voice entered by a user of the artificial intelligence application, the preset interface bound to the operation description template executed by the interface bound to the operation description template, when invoked, is used for: finding out the articles belonging to the content category having a time length from the updating time to current time shorter than a time length threshold provided by the content supplier; sorting the found articles based on the time length from the updating time to the current time; and successively playing the articles in an order of the sorted articles.

After an artificial intelligence application integrated with a plurality of operation description templates and capable of accessing the piece of content provided by the content supplier through the man-machine dialogue is constructed, a user of the artificial intelligence application enters “playing technological news of the Baijiahao,” which matches the operation description template {playing, Baijiahao, technology, news}. As long as the actual operation transfers the parameters Baijiahao, technology, and news into a pre-bound preset interface of the operation description template {playing, Baijiahao, technology, news}, the preset interface may be invoked to execute a logic in playing a piece of content to find out recently updated articles of the content type of technological news of the Baijiahao based on the storage address and the updating time in the content attribute of the articles, and then play each article on technological news among all of the recently updated articles on technological news sequentially.

In some optional implementations of the embodiment, when the operation type of the operation described by the constructed operation description template is playing a piece of content, and when the constructed operation description template containing the word associated with the operation type of the operation described by the operation description template, the name of the content supplier, and the content attribute, such as the author name Silicon Valley Insight of the pieces of content, matches the sentence corresponding to the voice entered by a user of the artificial intelligence application, the preset interface bound to the operation description template executed by the interface bound to the operation description template, when invoked, is used for: finding out the articles having the content attribute having a time length from the updating time to the current time shorter than the time length threshold provided by the content supplier; sorting the found articles based on the time length from the updating time to the current time; and successively playing the articles in an order of the sorted articles.

After an artificial intelligence application integrated with a plurality of operation description templates and capable of accessing the piece of content provided by the content supplier through the man-machine dialogue is constructed, a user of the artificial intelligence application enters “playing the 36Kr of the Baijiahao,” which matches the operation description template {playing, Baijiahao, 36Kr}. As long as the actual operation transfers parameters Baijiahao, and 36Kr into a pre-bound preset interface of the operation description template {playing, Baijiahao, 36Kr}, the interface may be invoked to execute a logic in playing to find out articles of the type of the Baijiahao, first play “playing 36Kr for you, from the Baijiahao,” and then play each article of the 36Kr of the Baijiahao one by one.

step 204: constructing an artificial intelligence application capable of accessing the piece of content provided by the content supplier through a man-machine dialogue using the operation description template and the preset interface bound to the operation description template.

In the embodiment, a plurality of operation description templates may be used for identifying operations expected by a user of the artificial intelligence application capable of accessing the piece of content provided by the content supplier through the man-machine dialogue to be completed by the artificial intelligence application, and the preset interface bound to the operation description templates may be used for completing operations described by the operation description templates. The plurality of operation description templates and an interface bound to each of the operation description templates may be integrated into a module corresponding to a man-machine dialogue function, and the module corresponding to the man-machine dialogue function may be combined with a module corresponding to a voice recognition function, to construct an artificial intelligence application capable of accessing the piece of content provided by the content supplier through the man-machine dialogue.

The artificial intelligence application capable of accessing the piece of content provided by the content supplier through the man-machine dialogue may be constructed using the operation description templates and the preset interfaces bound to the operation description templates by integrating the operation description templates and the preset interfaces bound to the operation description templates into a module running on the artificial intelligence operating system, and integrating the module and a voice recognition module of the artificial intelligence operating system into a module for use in the man-machine dialogue. Then, the artificial intelligence application capable of accessing the piece of content provided by the content supplier through the man-machine dialogue may be constructed using the module for use in the man-machine dialogue.

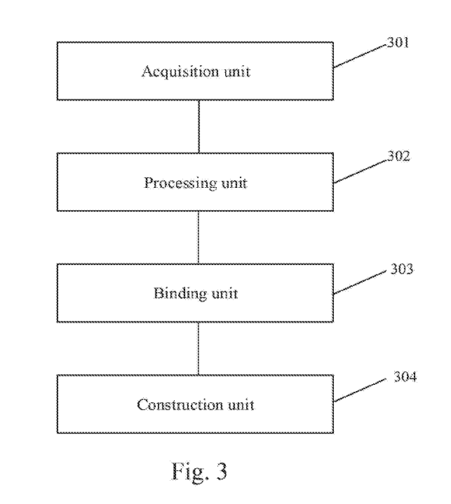

Referring to FIG. 3, as an implementation of the method shown in the above figures, some embodiments of the disclosure provide an embodiment of an apparatus for constructing an artificial intelligence application. The embodiment of the apparatus corresponds to the embodiment of the method shown in FIG. 2.

As shown in FIG. 3, the apparatus for constructing an artificial intelligence application includes: an acquisition unit 301, a processing unit 302, a binding unit 303, and a construction unit 304. The acquisition unit 301 is configured for acquiring a content description document corresponding to a piece of content provided by a content supplier and a hierarchical relationship between content categories, the content description document including: a content attribute defined in a preset format; the processing unit 302 is configured for analyzing the content description document using an analysis method corresponding to the preset format to obtain the content attribute, and constructing an operation description template based on the hierarchical relationship between the content categories, or the content attribute, the operation description template used for matching a sentence corresponding to a user-entered voice; the binding unit 303 is configured for binding the operation description template to a preset interface of an operation type of an operation described by the operation description template, the preset interface being encapsulated with code for executing the operation described by the operation description template based on the content attribute, the preset interface being invoked when the bound operation description template matches the sentence corresponding to the user-entered voice; and the construction unit 304 is configured for constructing an artificial intelligence application capable of accessing the piece of content provided by the content supplier through a man-machine dialogue using the operation description template and the preset interface bound to the operation description template.

In some optional implementations of the embodiment, when the operation description template includes a word associated with the operation type of the operation described by the operation description template, and a name of the content supplier, a type of the piece of content provided by the content supplier is an article, and the operation type is opening a piece of content, the preset interface bound to the operation description template, when invoked, is used for: finding out the articles having a time length from the updating time to current time shorter than a time length threshold among all of the articles provided by the content supplier; sorting the found articles based on the time length from the updating time to the current time; and displaying the sorted articles to the user of the artificial intelligence application capable of accessing the piece of content provided by the content supplier through the man-machine dialogue.

In some optional implementations of the embodiment, when the operation description template includes the word associated with the operation type of the operation described by the operation description template, the name of the content supplier, and a content category, a type of the piece of content provided by the content supplier is an article, and the operation type is opening a piece of content, the preset interface bound to the operation description template, when invoked, is used for: finding out the articles belonging to the content category having a time length from the updating time to current time shorter than a time length threshold provided by the content supplier; sorting the found articles based on the time length from the updating time to the current time; and displaying the sorted articles to the user of the artificial intelligence application capable of accessing the piece of content provided by the content supplier through the man-machine dialogue.

In some optional implementations of the embodiment, when the operation description template includes the word associated with the operation type of the operation described by the operation description template, the name of the content supplier, and a content attribute, a type of the piece of content provided by the content supplier is an article, and the operation type is opening a piece of content, the preset interface bound to the operation description template, when invoked, is used for: finding out the articles having the content attribute having a time length from the updating time to the current time shorter than the time length threshold provided by the content supplier; sorting the found articles based on the time length from the updating time to the current time; and displaying the sorted articles to the user of the artificial intelligence application capable of accessing the piece of content provided by the content supplier through the man-machine dialogue.

In some optional implementations of the embodiment, when the operation description template includes the word associated with the operation type of the operation described by the operation description template, and the name of the content supplier, the type of the piece of content provided by the content supplier is an article, and the operation type is playing a piece of content, the preset interface bound to the operation description template, when invoked, is used for: finding out articles having a time length from the updating time to the current time shorter than the time length threshold among all of the articles provided by the content supplier; sorting the found articles based on the time length from the updating time to the current time; and successively playing the articles in an order of the sorted articles.

In some optional implementations of the embodiment, when the operation description template includes the word associated with the operation type of the operation described by the operation description template, the name of the content supplier, and the content category, the type of the piece of content provided by the content supplier is an article, and the operation type is playing a piece of content, the preset interface bound to the operation description template, when invoked, is used for: finding out the articles belonging to the content category having a time length from the updating time to current time shorter than a time length threshold provided by the content supplier; sorting the found articles based on the time length from the updating time to the current time; and successively playing the articles in an order of the sorted articles.

In some optional implementations of the embodiment, when the operation description template includes the word associated with the operation type of the operation described by the operation description template, the name of the content supplier, and the content attribute, the type of the piece of content provided by the content supplier is an article, and the operation type is playing a piece of content, the preset interface bound to the operation description template, when invoked, is used for: finding out the articles having the content attribute having a time length from the updating time to the current time shorter than the time length threshold provided by the content supplier; sorting the found articles based on the time length from the updating time to the current time; and successively playing the articles in an order of the sorted articles.

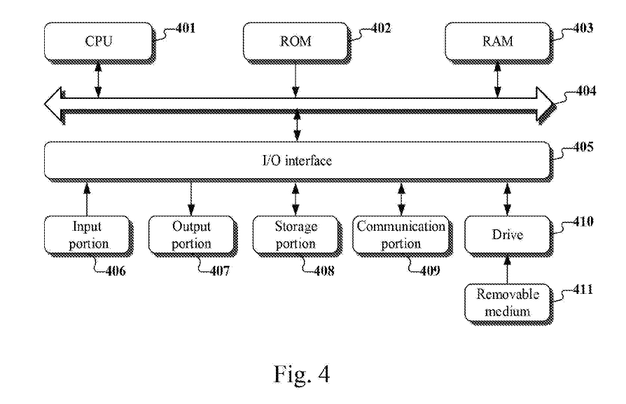

FIG. 4 shows a schematic diagram of a structure of a computer system suitable for implementing a server according to an embodiment of the disclosure.

As shown in FIG. 4, the computer system includes a central processing unit (CPU) 401, which may execute a variety of appropriate actions and processing based on programs stored in a read only memory (ROM) 402 or programs loaded from a storage part 408 to a random access memory (RAM) 403. A variety of programs and data required to operate the computer system are also stored in the RAM 403. The CPU 401, the ROM 402 and the RAM 403 are connected with one another through a bus 404. An input/output (I/O) interface 405 is also connected with the bus 404.

The following components are connected with the I/O interface 405: an input part 406; an output part 407; a storage part 408 including a hard disk and the like; and a communication part 409 including a network interface card, such as a LAN card and a modem. The communication part 409 executes communication processing via a network such as the Internet. The drive 410 is also connected with the I/O interface 405 as required. A removable medium 411, such as a magnetic disc, an optical disc, and a semiconductor memory, is installed in the drive 410 as required, to facilitate computer programs read thereon to be installed in the storage part 408 as required.

In particular, the process according to the embodiment of the disclosure may be implemented as a computer program. For example, the embodiment of the disclosure includes a computer program product, which includes a computer program carried in a computer readable medium, and the computer program contains an instruction for executing the method as shown in the process diagram. The computer program may be downloaded and installed from the network through the communication part 409, and/or installed from the removable medium 411. When the computer program is executed by the central processing unit (CPU) 401, the above functions defined in the method according to some embodiments of the disclosure are executed.

Some embodiments of the disclosure further provide a server, which may be equipped with one or more processors; and a memory for storing one or more programs, where the one or more programs may contain instructions for executing the operations described in the steps 201-204. The one or more programs enable, when executed by the one or more processors, the one or more processors to execute the operations described in the steps 201-204.

Some embodiments of the disclosure further provide a computer readable medium, which may be included in the server; and may also separately exist without being assembled into the server. The computer readable medium carries one or more programs. The one or more programs enable, when executed by a terminal, the terminal to: acquire a content description document corresponding to a piece of content provided by a content supplier and a hierarchical relationship between content categories, the content description document including: a content attribute defined in a preset format; analyze the content description document using an analysis method corresponding to the preset format to obtain the content attribute, and construct an operation description template based on the hierarchical relationship between the content categories, or the content attribute, the operation description template used for matching a sentence corresponding to a user-entered voice; bind the operation description template to a preset interface of an operation type of an operation described by the operation description template, the preset interface being encapsulated with code for executing the operation described by the operation description template based on the content attribute, the preset interface being invoked when the bound operation description template matches the sentence corresponding to the user-entered voice; and construct an artificial intelligence application capable of accessing the piece of content provided by the content supplier through a man-machine dialogue using the operation description template and the preset interface bound to the operation description template.

It should be noted that the computer readable medium in some embodiments of the present disclosure may be computer readable storage medium. An example of the computer readable storage medium may include, but not limited to: semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In some embodiments of the present disclosure, the computer readable storage medium may be any physical medium containing or storing programs which can be used by a command execution system, apparatus or element or incorporated thereto. The computer readable medium may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The above description only provides an explanation of the preferred embodiments of the present application and the technical principles used. It should be appreciated by those skilled in the art that the inventive scope of the present application is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present application are examples.

What is claimed is:

1. A method for constructing an artificial intelligence application, comprising:
acquiring a content description document corresponding to a piece of content provided by a content supplier and a hierarchical relationship between content categories, the content description document comprising: a content attribute defined in a preset format;
analyzing the content description document using an analysis method corresponding to the preset format to obtain the content attribute, and constructing an operation description template based on the hierarchical relationship between the content categories, or the content attribute, the operation description template used for matching a sentence corresponding to a user-entered voice;
binding the operation description template to a preset interface of an operation type of an operation described by the operation description template, the preset interface being encapsulated with code for executing the operation described by the operation description template based on the content attribute, the preset interface being invoked in response to determining that the bound operation description template matches the sentence corresponding to the user-entered voice; and
constructing an artificial intelligence application capable of accessing the piece of content provided by the content supplier through a man-machine dialogue using the operation description template and the preset interface bound to the operation description template,
wherein the method is performed by at least one processor.

2. The method according to claim 1, wherein the content attribute comprises: a storage address of the piece of content, updating time of the piece of content, a content category of the piece of content, and an author of the piece of content.

3. The method according to claim 2, wherein the operation description template includes a word associated with the operation type of the operation described by the operation description template, and a name of the content supplier, a type of the piece of content provided by the content supplier is an article, and the operation type is opening a piece of content; and
the preset interface bound to the operation description template, when invoked, is used for:
finding out the articles including a time length from the updating time to current time shorter than a time length threshold among all of the articles provided by the content supplier;
sorting the found articles based on the time length from the updating time to the current time; and
displaying the sorted articles to a user of the artificial intelligence application capable of accessing the piece of content provided by the content supplier through the man-machine dialogue.

4. The method according to claim 2, wherein the operation description template includes a word associated with the operation type of the operation described by the operation description template, a name of the content supplier, and the content category, a type of the piece of content provided by the content supplier is an article, and the operation type is opening a piece of content; and
the preset interface bound to the operation description template, when invoked, is used for:
finding out the articles belonging to the content category including a time length from the updating time to current time shorter than a time length threshold provided by the content supplier;
sorting the found articles based on the time length from the updating time to the current time; and
displaying the sorted articles to a user of the artificial intelligence application capable of accessing the piece of content provided by the content supplier through the man-machine dialogue.

5. The method according to claim 2, wherein the operation description template includes a word associated with the operation type of the operation described by the operation description template, a name of the content supplier, and the content attribute, a type of the piece of content provided by the content supplier is an article, and the operation type is opening a piece of content; and
the preset interface bound to the operation description template, when invoked, is used for:
finding out the articles including the content attribute including a time length from the updating time to the current time shorter than the time length threshold provided by the content supplier;
sorting the found articles based on the time length from the updating time to the current time; and
displaying the sorted articles to a user of the artificial intelligence application capable of accessing the piece of content provided by the content supplier through the man-machine dialogue.

6. The method according to claim 2, wherein the operation description template includes a word associated with the operation type of the operation described by the operation description template, and a name of the content supplier, a type of the piece of content provided by the content supplier is an article, and the operation type is playing a piece of content; and
the preset interface bound to the operation description template, when invoked, is used for:
finding out articles including a time length from the updating time to the current time shorter than the time length threshold among all of the articles provided by the content supplier;
sorting the found articles based on the time length from the updating time to the current time; and
successively playing the articles in an order of the sorted articles.

7. The method according to claim 2, wherein the operation description template includes a word associated with the operation type of the operation described by the operation description template, a name of the content supplier, and the content category, a type of the piece of content provided by the content supplier is an article, and the operation type is playing a piece of content; and
the preset interface bound to the operation description template, when invoked, is used for:
finding out the articles belonging to the content category including a time length from the updating time to current time shorter than a time length threshold provided by the content supplier;
sorting the found articles based on the time length from the updating time to the current time; and
successively playing the articles in an order of the sorted articles.

8. The method according to claim 2, wherein the operation description template includes a word associated with the operation type of the operation described by the operation description template, a name of the content supplier, and the content attribute, a type of the piece of content provided by the content supplier is an article, and the operation type is playing a piece of content; and
the preset interface bound to the operation description template, when invoked, is used for:
finding out the articles including the content attribute including a time length from the updating time to the current time shorter than the time length threshold provided by the content supplier;
sorting the found articles based on the time length from the updating time to the current time; and
successively playing the articles in an order of the sorted articles.

9. An apparatus for constructing an artificial intelligence application, comprising:
at least one processor; and
a memory storing instructions, the instructions when executed by the at least one processor, cause the at least one processor to perform operations, the operations comprising:
acquiring a content description document corresponding to a piece of content provided by a content supplier and a hierarchical relationship between content categories, the content description document comprising: a content attribute defined in a preset format;
analyzing the content description document using an analysis method corresponding to the preset format to obtain the content attribute, and constructing an operation description template based on the hierarchical relationship between the content categories, or the content attribute, the operation description template used for matching a sentence corresponding to a user-entered voice;
binding the operation description template to a preset interface of an operation type of an operation described by the operation description template, the preset interface being encapsulated with code for executing the operation described by the operation description template based on the content attribute, the preset interface being invoked in response to determining that the bound operation description template matches the sentence corresponding to the user-entered voice; and
constructing an artificial intelligence application capable of accessing the piece of content provided by the content supplier through a man-machine dialogue using the operation description template and the preset interface bound to the operation description template.

10. The apparatus according to claim 9, wherein in response to determining that the operation description template includes a word associated with the operation type of the operation described by the operation description template, and a name of the content supplier, a type of the piece of content provided by the content supplier is an article, and the operation type is opening a piece of content, the preset interface bound to the operation description template, when invoked, is used for: finding out the articles including a time length from the updating time to current time shorter than a time length threshold among all of the articles provided by the content supplier; sorting the found articles based on the time length from the updating time to the current time; and displaying the sorted articles to a user of the artificial intelligence application capable of accessing the piece of content provided by the content supplier through the man-machine dialogue.

11. The apparatus according to claim 9, wherein in response to determining that the operation description template includes the word associated with the operation type of the operation described by the operation description template, a name of the content supplier, and a content category, a type of the piece of content provided by the content supplier is an article, and the operation type is opening a piece of content, the preset interface bound to the operation description template, when invoked, is used for: finding out the articles belonging to the content category including a time length from the updating time to current time shorter than a time length threshold provided by the content supplier; sorting the found articles based on the time length from the updating time to the current time; and displaying the sorted articles to a user of the artificial intelligence application capable of accessing the piece of content provided by the content supplier through the man-machine dialogue.

12. The apparatus according to claim 9, wherein in response to determining that the operation description template includes the word associated with the operation type of the operation described by the operation description template, a name of the content supplier, and the content attribute, a type of the piece of content provided by the content supplier is an article, and the operation type is opening a piece of content, the preset interface bound to the operation description template, when invoked, is used for: finding out the articles including the content attribute including a time length from the updating time to the current time shorter than the time length threshold provided by the content supplier; sorting the found articles based on the time length from the updating time to the current time; and displaying the sorted articles to a user of the artificial intelligence application capable of accessing the piece of content provided by the content supplier through the man-machine dialogue.

13. The apparatus according to claim 9, wherein in response to determining that the operation description template includes the word associated with the operation type of the operation described by the operation description template, and a name of the content supplier, a type of the piece of content provided by the content supplier is an article, and the operation type is playing a piece of content, the preset interface bound to the operation description template, when invoked, is used for: finding out articles including a time length from the updating time to the current time shorter than the time length threshold among all of the articles provided by the content supplier; sorting the found articles based on the time length from the updating time to the current time; and successively playing the articles in an order of the sorted articles.

14. The apparatus according to claim 9, wherein in response to determining that the operation description template includes the word associated with the operation type of the operation described by the operation description template, a name of the content supplier, and the content category, a type of the piece of content provided by the content supplier is an article, and the operation type is playing a piece of content, the preset interface bound to the operation description template, when invoked, is used for: finding out the articles belonging to the content category including a time length from the updating time to current time shorter than a time length threshold provided by the content supplier; sorting the found articles based on the time length from the updating time to the current time; and successively playing the articles in an order of the sorted articles.

15. The apparatus according to claim 9, wherein in response to determining that the operation description template includes the word associated with the operation type of the operation described by the operation description template, a name of the content supplier, and the content attribute, a type of the piece of content provided by the content supplier is an article, and the operation type is playing a piece of content, the preset interface bound to the operation description template, when invoked, is used for: finding out the articles including the content attribute including a time length from the updating time to the current time shorter than the time length threshold provided by the content supplier; sorting the found articles based on the time length from the updating time to the current time; and successively playing the articles in an order of the sorted articles.

16. A non-transitory computer-readable storage medium storing a computer program, the computer program when executed by one or more processors, causes the one or more processors to perform operations, the operations comprising:
acquiring a content description document corresponding to a piece of content provided by a content supplier and a hierarchical relationship between content categories, the content description document comprising: a content attribute defined in a preset format;
analyzing the content description document using an analysis method corresponding to the preset format to obtain the content attribute, and constructing an operation description template based on the hierarchical relationship between the content categories, or the content attribute, the operation description template used for matching a sentence corresponding to a user-entered voice;
binding the operation description template to a preset interface of an operation type of an operation described by the operation description template, the preset interface being encapsulated with code for executing the operation described by the operation description template based on the content attribute, the preset interface being invoked in response to determining that the bound operation description template matches the sentence corresponding to the user-entered voice; and
constructing an artificial intelligence application capable of accessing the piece of content provided by the content supplier through a man-machine dialogue using the operation description template and the preset interface bound to the operation description template.
